(19) United States
(12) Patent Application Publication
(10) Pub. No.: US 2026/0304588 A1
(43) Pub. Date: Oct. 1, 2026

(54) A NOZZLE FOR GENERATING AN ATMOSPHERIC PRESSURE PLASMA

(71) Applicant: Freiburger Medizintechnik GmbH, Freiburg (DE)

(72) Inventors: Markus Altenburger, Freiburg (DE); Michael Bergmann, Freiburg (DE); Elena Burkin, Freiburg (DE); Florian Engesser, Freiburg (DE); Loic Ledernez, Freiburg (DE)

(21) Appl. No.: 19/475,992

(22) PCT Filed: Apr. 9, 2024
(86) PCT No.: PCT/EP2024/059565

§ 371 Date: Oct. 16, 2025

(30) Foreign Application Priority Data
Apr. 19, 2023 (EP) 23168730.2

(51) Int. Cl. H05H 1/48; H05H 1/24

(52) U.S. Cl. CPC H05H 1/48; H05H 1/2418; H05H 2245/30

(57) ABSTRACT

A nozzle for generating an atmospheric pressure plasma having a monopolar electrode. The nozzle (1) comprises a foil nozzle (10) with an upper and a lower foil (12, 13) between which a gas channel (16) is formed. An outlet (14) is formed in the upper foil (13) and the electrode (11) is exposed in the area of the outlet (14). The nozzle (1) may comprise a V-shaped recess (14′) being formed on a tip (17) of the foil nozzle (10).

### CROSS-REFERENCE TO RELATED APPLICATIONS

This is the United States national phase of International Patent Application No. PCT/EP 2024/059565, filed Apr. 9, 2024, which claims priority to European Patent Application No. 23168730.2, filed on Apr. 19, 2023, the entire contents of each of which are hereby incorporated by reference herein.

### FIELD OF THE DISCLOSURE

The present disclosure relates to a nozzle for generating an atmospheric pressure plasma having a monopolar electrode.

### BACKGROUND

Nozzles for generating an atmospheric pressure plasma are known in the art. Said nozzles may be used in connection with devices for providing a gas as well as a pulsed voltage in order to generate an atmospheric pressure plasma. Non-thermal atmospheric pressure plasma may be used in medical devices for treating the human body. Medical devices often comprise a handle where the plasma is generated and a nozzle where the plasma exits the device. In order to meet hygiene requirements for medical devices, the nozzle is replaceable and may be restricted to singular use. An electrode arrangement for a plasma-jet device as well as a plasma head having such an electrode arrangement is known from WO 2022/013 229 A1. The electrode arrangement comprises printed circuit boards with conducting paths.

The design of the device and particularly of the nozzle may meet different requirements depending on the field of application and the surface to be treated. A device and a nozzle for treating large areas on the surface like the treatment of skin may differ from a nozzle for an invasive, subcutaneous treatment.

The first objective of the present invention is to provide a nozzle for the treatment of body structures, in particular bone structures or artificial bone structures, which are not exposed and/or not freely accessible. A further aspect is to provide the generation of plasma close to the structure to be treated for minimizing losses and also minimizing the treatment of neighbouring structures.

### SUMMARY

In one example, a nozzle for generating atmospheric pressure plasma has a monopolar electrode. The nozzle comprises a foil nozzle with an upper and a lower foil between which a gas channel is formed. An outlet is formed in the upper foil and the electrode is exposed in the area of the outlet.

The foil nozzle may be of a sandwich-design, wherein a gas channel is arranged in between an upper and a lower foil. The electrode may also be arranged between the upper and the lower foil. In one embodiment the electrode may be attached to the lower foil. The outlet of the gas channel may be formed as a recess or opening in the upper foil. The shape of the outlet may, for example, be circular, elliptical, arch-shaped, or polygonal as well as combinations thereof or may have any other shape. The electrode is exposed or bare in the area of the outlet. This may include that the electrode is particularly exposed in the area of a projection of the shape of the outlet on the lower foil. Such an arrangement promotes a generation of the plasma in or close to the outlet, through which it exits the foil nozzle.

The nozzle comprises, in one embodiment, a V-shaped recess being formed on a tip of the foil nozzle. The V-shaped form may include any recess formed into the central area of a basically flat or straight tip, particularly swallow-tail shapes, curved or similar shapes. The recess may extend over at least a part of the tip, preferably over a central part of the tip. In one embodiment, the V-shaped recess may extend basically over the complete width of the tip. The V-shaped tip facilitates particularly the treatment of bone or implant structures such as the treatment of periimplantitis on a metal tooth implant, for which the foil nozzle has to be inserted between the implant and the gingiva and in gingival pockets, respectively. The V-shaped tip facilitates the insertion and the movement into the pocket by reducing stick-slip-phenomena, especially along the thread of the implant screw. Additionally, the V-shape promotes the application of the foil nozzle on a spherical surface of the implant by the nozzle being aligned to said surface. Similar effects may be achieved when other body structures like bone, teeth or implants, prosthesis are treated. An example for prosthesis may be hip joint or knee joint prosthesis which are treated after implantation with plasma for removing bacteria.

In one embodiment, the foil nozzle is flexible bendable in a direction orthogonally to the upper and lower surface of the foil. The upper and the lower foil are basically arranged in parallel as regards to their planer extension. The planer design of the foils in connection with a rather limited height of the gas channel allows the bendability by a force orthogonally to the upper and lower foil. The foil nozzle may be bendable about an axis orthogonally to the longitudinal extension of the foil nozzle which longitudinal extension may be aligned with the flow direction in gas channel or about an axis aligned with longitudinal extension of the foil nozzle. The bendability about the orthogonal axis may facilitate the insertion into flat openings like gingival pockets and the bendability about the longitudinal axis allows an alignment with elliptical or circular surfaces. The height of the foil nozzle from the lower foil to the upper foil may have smaller dimensions compared to the width of the foil nozzle from one longitudinal side to the opposite longitudinal side. The width/height ratio may be in the range of 2 to 10, preferably in the range of 2 to 5. Further, the length of the free-standing part of the foil nozzle extending from the connector to the tip may be of greater dimensions compared to its width. The length/width ratio may be in the range of 2 to 10 preferably in the range of 2 to 5.

The foil nozzle may, in one example, have multiple outlets. The gas outlets may be located in the upper foil or, in case a spacer is arranged between the upper foil and the lower foil, the outlets also may extend from the upper foil into the spacer or may even be designed as side outlets in the spacer. The outlets may have all the same shape or different shapes. The gas outlets may be arranged in an irregular pattern or regular pattern, in particular in a point or line symmetrical pattern. The symmetrical axis may extend along the width or the length of the foil nozzle.

In one embodiment, each of the outlets have a corresponding electrode member of the monopolar electrode. The arrangement of an electrode member for each outlet allows a dimensioning of each electrode according to the requirements at the corresponding outlet. In one embodiment, each of the electrode members may be contactable separately in order to control each electrode member separately. Controlling includes, in particular, the application of an individual voltage to each of the electrode members which may vary over time, for example a pulsed voltage. In this case, each of the electrode members may be considered as a separate electrode. However, in case of multiple electrodes, the nozzle may be designed such that it comprises only monopolar electrodes and the counter electrode is applied to the object to be treated.

In an alternative embodiment, the multiple electrode members are designed as forks or branches of a singular electrode. In a further alternative, the foil nozzle comprises only a singular electrode which is bared in the area of the multiple outlets or has multiple bared areas for each outlet.

In one embodiment, the upper and lower foil are connected to each other or bonded together at their lateral end portions and at their tip portion. A circumferential connection at three sides is provided, forming a gas channel between the upper foil and the lower foil. The cross-sectional shape of the foil nozzle may be basically elliptical or arch-shaped with connection points at its main vertices. The elliptical shape may be achieved by a corresponding support of the foil sheets on a connector for connecting the nozzle to the plasma generating device.

In an alternative embodiment, the connection between the upper and the lower foil is formed by a spacer forming a side wall of the foil nozzle. The spacer may be arranged on at least three sides of the foil nozzle, in particular on two lateral portions as well as on the tip portion. This allows a basically rectangular cross section of the foil nozzle as well as of the gas channel. A rectangular cross section with a greater width than height allows a bendability as described above.

In one embodiment, at least one of the upper foil, the lower foil and the side wall is made of a flexible PCB material, preferably of polyamide or FR4. A flexible PCB material is a material used for printed circuit boards (PCB). The upper foil and the lower foil may be made of a sheet-like flexible PCB material. The usage of a PCB material may have, in particular for the lower foil, synergetic effects when the lower foil is used as a carrier for the electrode. The electrode may be applied as a conducting track on the PCB-material.

The electrode and in particular the conducting track may, in one embodiment, be formed out of copper, preferably out of copper with a gold plating. In alternative embodiments the electrode may be formed out of any conductive material.

In one embodiment, the electrode may be formed as a conductive track on the lower foil, particularly on the inner surface of the lower foil. The PCB with the conductive track may be formed in a manner known in the art. The PCB may comprise multiple conductive tracks, for example providing a conductive track for each gas outlet. The PCB may be of an electrically insulating material. When the conductive track is formed on the inner surface of the lower foil, the conductive track may extend into the gas channel allocated between the lower and the upper foil.

In order to avoid a heating of the spacer beyond a critical temperature and a deformation of the spacer, in one embodiment, the electrode is spaced apart from the spacer. The electrode may in particular be spaced apart from the lateral side wall and, if applicable, of the spacer. The gap between the spacer and the electrode may be provided by a groove in the lower foil or PCB, respectively. The groove may be formed by removal of the conductive layer during production of the conductive track and/or by removing parts of the PCB-material.

In one embodiment, the electrode may be partially coated with a varnish serving as an insulator. The coating of the electrode with an insulator may be such that the electrode is covered in the gas channel and only bared in the area of the gas outlet. Such an arrangement prohibits an unwanted ignition of the gas during operation of the nozzle and the generation of plasma within the gas channel. The electrode may also be coated by an insulator other than a varnish. Alternatively, the electrode may run inside the foil or the spacer or covered in a sandwich arrangement of the lower foil or the lower foil and the spacer.

In one embodiment, the nozzle comprises a connector at a base of the foil nozzle. The connector is adapted to connect the nozzle with a device or a handle of a device for generating plasma. The connector may provide a gas inlet and an electrical connector. The electrical connector may provide an electrical connection to a power supply for providing a voltage or modulating a voltage on the electrodes. The power supply may particularly be a pulsed voltage source. The base of the foil nozzle is arranged at the portion opposite to the tip portion.

The connector may, in one embodiment, be of moulded plastic. During production, the foil nozzle is inserted into a mould and the base of the foil nozzle is over-moulded by a plastic material.

### BRIEF DESCRIPTION OF THE DRAWINGS

Preferred embodiments of the present invention are described by way of example only with reference to the accompanying drawings, wherein

FIG. 1 illustrates an example nozzle for generating an atmospheric pressure plasma;

FIG. 2 is an illustration of the foil nozzle of FIG. 1;

FIG. 3 is a cross section of the foil nozzle of FIG. 2, taken from line A-A;

FIG. 3a is a detailed view of the cross-section of FIG. 3, taken from circle B;

FIGS. 4a to 4c are a second embodiment of a foil nozzle in different views;

FIGS. 5a and 5b are a third embodiment of a foil nozzle in different views.

### DETAILED DESCRIPTION

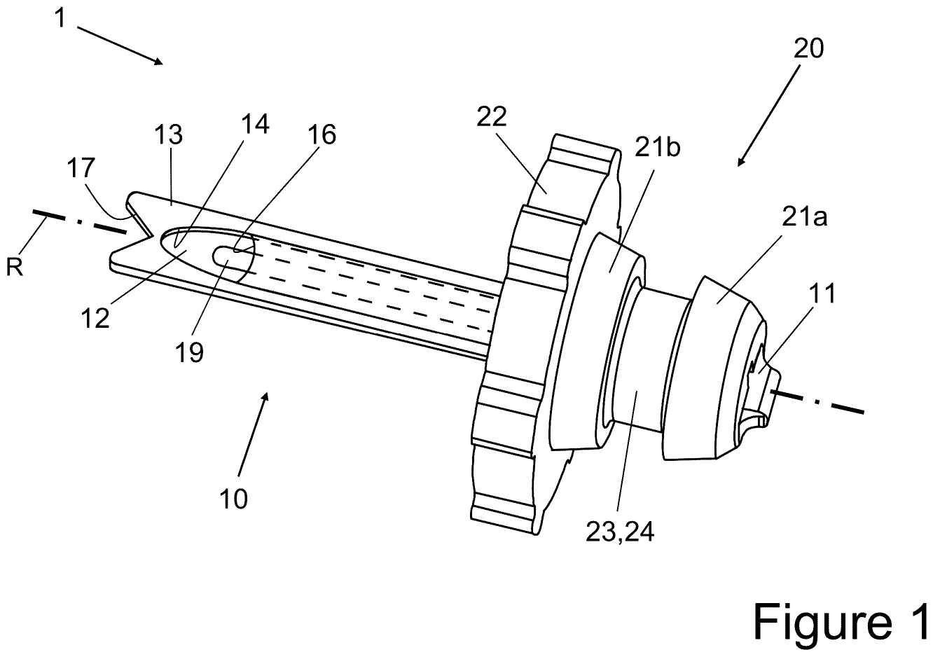

The present disclosure is directed to a nozzle for generating an atmospheric pressure plasma. An example nozzle 1, as shown in FIG. 1, may comprise a foil nozzle 10 and a connector 20. The foil nozzle 10 comprises a monopolar electrode 11. The foil nozzle 10 may be of an elongated shape wherein the connector 20 may be allocated on or around one end of the elongated foil nozzle 10. The electrode 11 is adapted to be connected to a power supply, preferably via or within the connector 20, for generating an atmospheric pressure plasma by igniting a gas. The foil nozzle 10 further comprises a gas channel 16 for directing a gas towards a tip 19 of the electrode 11. The foil nozzle 10 comprises a recess 14 as gas-outlet, which may be located in the area of the electrode tip 19.

The foil nozzle 10 may be of a flat, elongated shape with a lower foil 12 and an upper foil 13. Between the lower foil 12 and the upper foil 13 the gas channel 16 as well as the electrode 11 may be arranged wherein the lower foil 12 may serve as a carrier for the electrode 11. The foil may be a flexible material for printed circuit boards (PCB), preferably polyamide or FR4. The tip 17 of the foil nozzle 10, which may be on the end opposite to the connector 20, may have a recess in form of a V, resulting in a V-shaped tip.

The basic design of the foil nozzle 10 is a flat one such that the foil nozzle 10 is bendable when a force orthogonal to the lower and upper foils 12, 13 is applied while it is relatively rigid when a force orthogonal to the side wall is applied. Such bendable or flexible design is primarily achieved by usage of a bendable/flexible foil material as well by the dimensions of the foil nozzle 10 having a flat design. The width of the foil nozzle 10 from one side wall to the opposite side wall is multiple times of its height from the lower foil 12 to the upper foil 13.

In one embodiment, the lower foil 12 may have a thickness of about 45 μm and the upper foil 13 of 127 μm. The free-standing part of the foil nozzle 10 may have dimensions of 10 mm in length and 2 mm in width resulting in a length/width ratio of 5. The height or thickness of the nozzle 1 may be 300 μm resulting in a width/height ratio of 6.7. The spacer 15 between the lower and upper foil 12, 13 may have a width of 300 μm and a height or thickness of 125 μm. The electrode 11 attached to the rear foil 12 may have a thickness of 35 μm and a width of 500 μm.

The connector 20 is adapted for connecting the nozzle 1 to a handle or a base of a device for generating an atmospheric pressure plasma (not shown). Two basic functions may be implemented in the connector 20 besides connecting the nozzle 1 with the handle or device. One function is to implement an electric connection between the electrode 11 and electrical connectors of the device not shown. Therefore, the electrode 11 may be positioned in the connector 20 such that an electrical connection may be established. A second function is directing the gas from a gas source (not shown) to the gas channel 16. The gas may be supplied via the handle and/or the device for generating plasma. Therefore, the connector 20 may be designed such that a gas-tight connection from the source to the nozzle 1 can be established.

Additionally, the connector 20 or at least parts thereof may be designed rotationally symmetric such that the nozzle 1 can be rotated around its longitudinal axis R, which extends along the elongated shape of the nozzle 1/foil nozzle 10. The connector 20 may comprise a profiled surface 22 for rotating the nozzle 1 around its rotational axis R. The profiled surface 22 may be arranged at the circumferential surface of a disc. The surface 22 may be designed in a manner of a knurled nut.

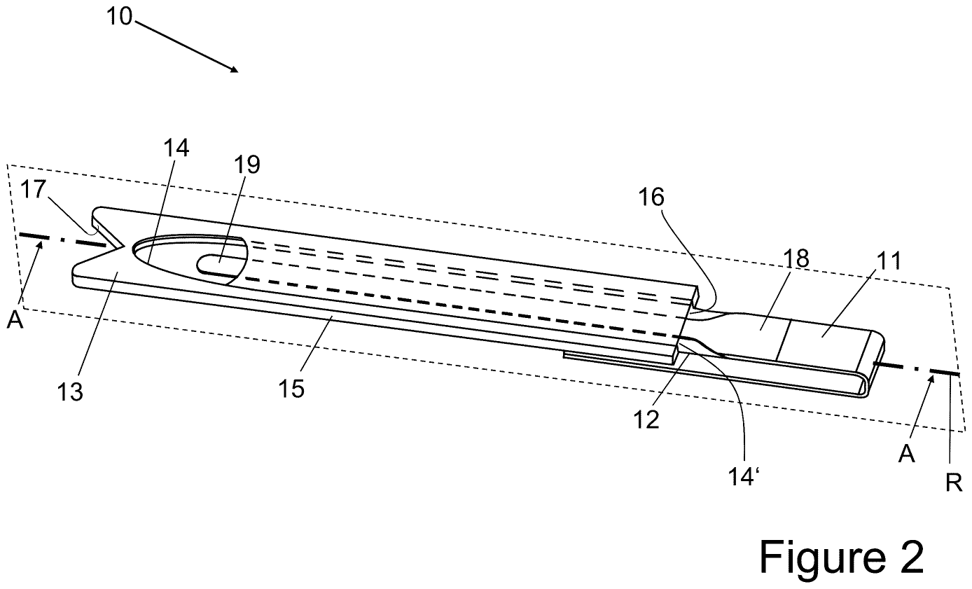

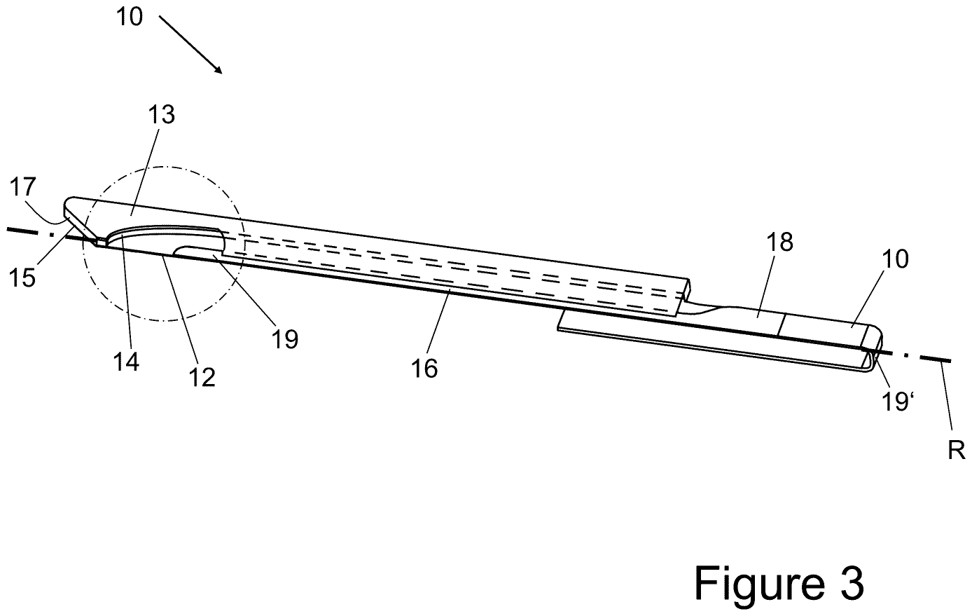

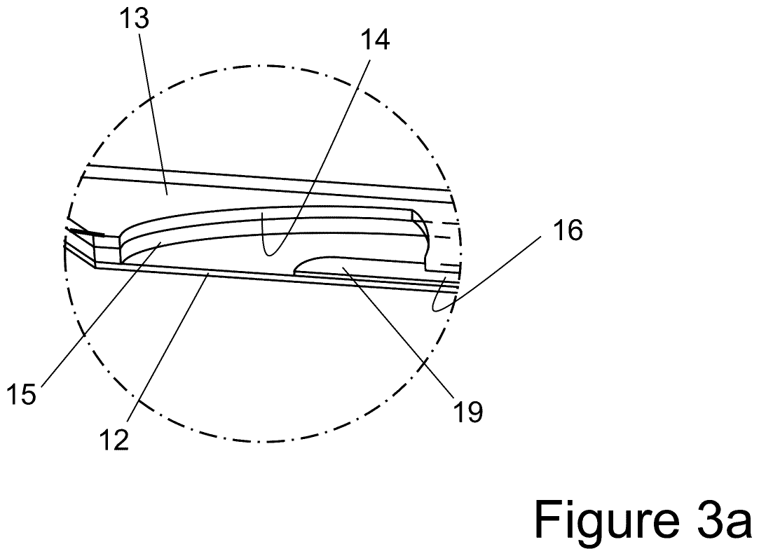

FIG. 1 shows a nozzle 1 with a foil nozzle 10 and a connector 20. A more detailed view of the foil nozzle 10 is shown in FIGS. 2, 3 and 3a. The foil nozzle 10 comprises a lower foil 12. The lower foil 12 is made out of a PCB-material and serves as a carrier for the electrode 11. The lower foil 12 may consist of polyamide or FR4. The foil nozzle 10 further comprises an upper foil 13. The lower foil 12 and the upper foil 13 are arranged in the segment extending from the connector 20, essentially congruent as regards to their exterior shape. At the end opposite to the connector 20, the tip of the foil nozzle 10 has a V-shaped recess building a V-shaped tip 17. Between the lower foil 12 and the upper foil 13 is a spacer 15, arranged such that the lower and the upper foils 12, 13 are spaced apart from each other. The upper and the lower foils 13, 12 are basically parallel to each other. The spacer 15 may be arranged on the longitudinal sides of the foil nozzle 10, which may extend along the longitudinal axis R, and at the V-shaped tip 17 such that the volume between the two foils 12, 13 is surrounded and sealed. The spacer 15 may be considered as a side wall and front face of the foil nozzle 10. In connection with the description of the nozzle, all surfaces or sections facing towards or located in the area of the tip 17 are referred to as “front surfaces” or “front or tip sections” and the surfaces or sections facing towards or located near the opposite end of the nozzle 1 are referred to as “rear surfaces” or “rear sections”. The spacer 15 may consist of the same material as the lower and upper foils 12, 13.

The chamber confined between the lower and upper foils 12, 13 and the spacer 15 is designed as a gas channel 16. The gas stream may be directed from a gas inlet 14′ within the connector 20 to a gas outlet 14 adjacent to the tip 17 of the foil nozzle 10. The gas outlet 14 may be designed as a recess in the upper foil 13. The recess 14 may be arranged in such way above the electrode tip 19 that the tip 19 is opposite to the gas outlet 14.

The connector 20 surrounds an end of the foil nozzle 10 opposite to the tip 17. The connector 20 has a basically rotationally symmetric outer shape in order to be rotatable connectable to a base or handle. The connector 20 comprises two conical sections 21a, 21b which are intermitted by an annular groove 23. The annular groove 23 serves as a gas inlet 24 for the nozzle 1 receiving gas from a source via device/handle. Further, an interlocking device of the base/handle may engage with the groove 23 in order to lock the nozzle 1 with the base or handle, respectively. Towards the tip 17 of the foil nozzle 10 the conical section 21b is followed by a profiled surface 22 in order to facilitate a rotation the nozzle 1 around its longitudinal axis R. The rear-face of the connector 20 opposite from the front-face 17 and the profiled surface 22 are designed such that the electrode 11 projects beyond the rear-face of the connector 20. The rear side of the nozzle 1 is designed, as shown in FIGS. 2 and 3, such that the lower foil/PCB 12 has U-shaped form and the electrode 11 is bared at a rear surface of the nozzle 1 in which area the electrode 11 extends beyond the rear surface of the connector 20. The shorter shank of the U-shape is completely over-moulded by the connector 20.

The lower foil 12 and the electrode 11 are bent such that the electrode 11 forms a rear face of the nozzle 1 in order to engage with an electrical connector of the handle/base and provide an electrical connection even during rotation of the nozzle 1.

As can be seen in FIG. 2, the gas inlet 14′ of the foil nozzle 10 is arranged at a rear face of the upper foil 13 and the spacer 15. The rear section of the foil nozzle 10 is overmoulded by the connector 20 in such way, that a sealed gas connection from the annular groove 23 of the connector 20 to the gas inlet 14′ of the foil nozzle 10 is provided.

In an alternative configuration, the annular groove 23 only serves for locking the nozzle 1 to the base/handle and the gas inlet 24 is designed at the rear face of the connector 20. As can be seen in FIG. 3, the electrode 11 is covered by a non-conductive material in the section between the electrode tip 19 and the rear face 19′ of the electrode. The electrode 11 may be covered by a varnish 18. By covering the electrode 11, an undesired ignition of the gas in the gas channel 16 is avoided.

FIG. 3a is a detailed illustration of the electrode tip 19 and gas outlet 14 section of the foil nozzle 10. The illustration shows the sandwich-design of the foil nozzle 10. The planar lower and upper foils 12, 13 are arranged parallel to each other and are spaced apart from each other and connected by the spacer 15 serving as side wall. The electrode 11 is attached to the lower foil 12 serving as electrode carrier.

The rotational axis R shown in FIG. 1 is located in the cutting surface A-A, which itself is a symmetry surface of the foil nozzle 10. The rotational axis R is located between the lower foil 12 and the upper foil 13, in particular halfway between the lower and upper foils 12, 13.

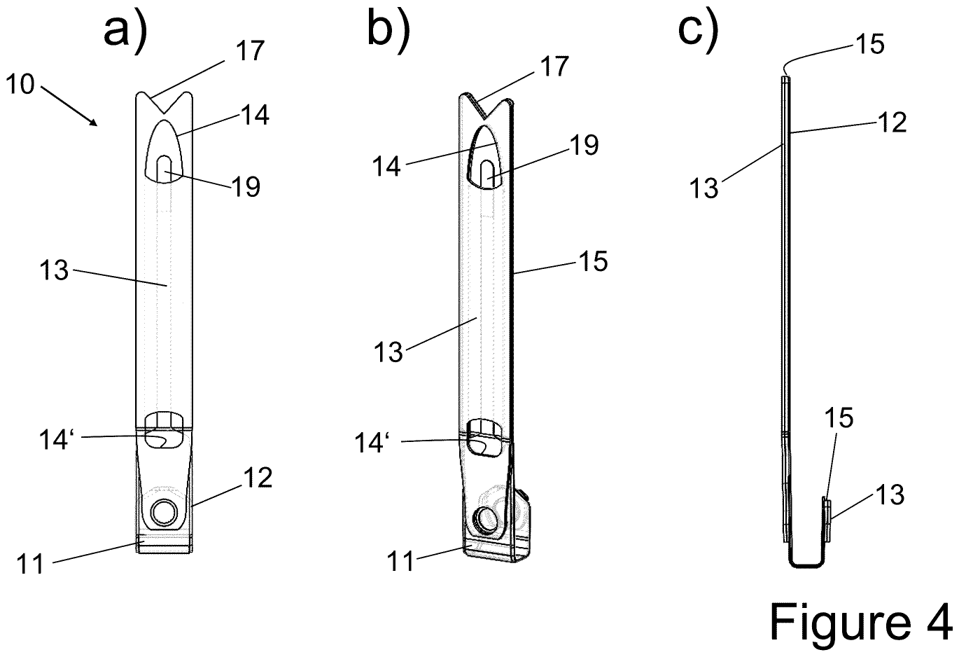

FIGS. 4a to 4c illustrate a second exemplary embodiment of a foil nozzle 10 according to the present invention. The second embodiment differs from the first embodiment, inter alia, in the design of the gas inlet 14′. The gas inlet 14′ in the second embodiment is formed by a recess in the upper foil 13, similar to the gas outlet 14. Additionally, the spacer 15 surrounds the gas channel 16 completely. It is designed as a circumferential seal between the lower and upper surface 12, 13. It serves as side walls as well as front and rear walls.

Additionally, a through hole may extend through both shanks of the U-shaped foil nozzle 10. The spacer 15 and the upper foil 13 may be applied to both shanks of the lower foil 12 while the rear face of the U-shaped foil nozzle 10 is free of spacer 15 and upper foil 13 in order to provide a contact surface of the electrode 11. On the shorter shank the spacer 15 and the upper foil 13 are applied such that they surround the through hole and provide a reinforcement therefore.

The through hole through both shanks of the U-shaped foil nozzle 10 provides a positional reference and also a support in the mould during moulding of the connector 20. Additionally, it provides a reinforcement for the connection between the foil nozzle 10 and the moulded connector 20.

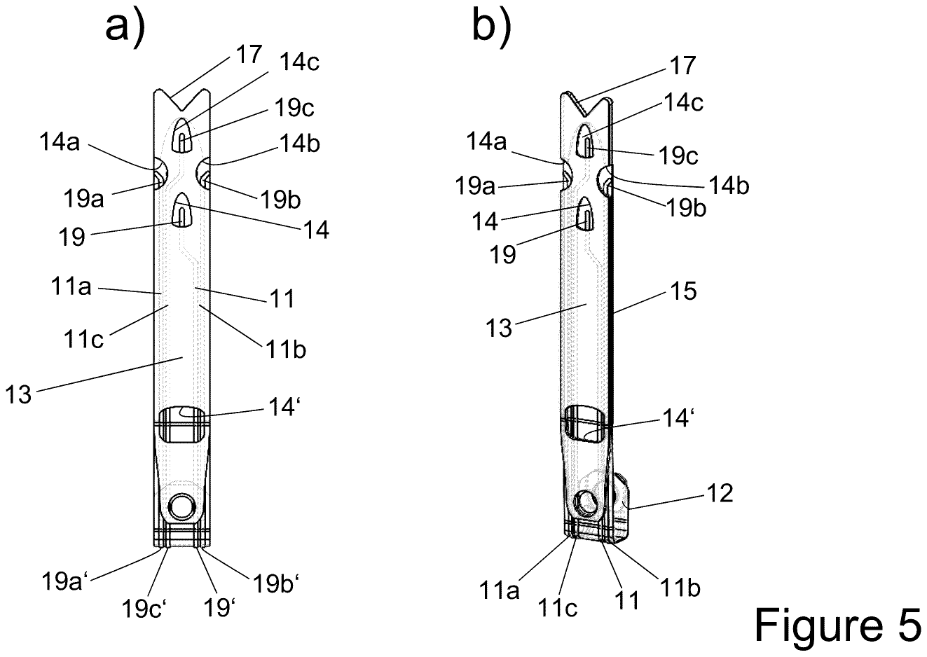

FIGS. 5a and 5b illustrate a third, exemplary embodiment of a foil nozzle 10 according to the present invention. It differs from the second embodiment according to FIGS. 4a to 4c in that it comprises not only one but four gas outlets 14-14c. Additional to the gas outlet 14 centrally in the upper foil 13 close to the tip 17, it further comprises two outlets 14a, 14b in the upper foil 13 and the spacer/side walls 15 as well as one outlet 14c in the upper foil 13 further back. Both gas outlets 14 and 14c are located above the rotational axis R and the cross-section surface A-A divides each of the two recesses into two mirrored parts. The first outlet 14 is arranged closer to the tip 17, wherein the fourth outlet 14c is arranged further back towards the rear face. The second gas outlet 14a and the third outlet 14b are formed as recesses extending from the longitudinal sides in the upper foil 13 and also in the side walls/spacer 15. Both recesses 14a, 14b are arranged at the same longitudinal position of the foil nozzle 10 and are shaped in a mirror inverted manner at opposite sides.

To each of the recesses 14 to 14c is a corresponding electrode tip 19 to 19c assigned. Each of the electrode tips 19 to 19c comprises a corresponding conducting path such that each electrode 11 to 11c may be served independently with electric power. Each electrode 11-11c has its own electrode rear face 19′ to 19c′ serving as electrical contact. The arrangement pattern of the outlets 14 to 14c and the electrode tips 19 to 19c in connection with the independent electrical control of electrodes 11 to 11c provides the possibility of influencing and modifying the structure and propagation of the atmospheric pressure plasma.

In an alternative embodiment (not shown) the foil nozzle 10 may comprise multiple gas outlets and electrode tips but only a singular electrode which branches out into multiple tips. Even though there is possibility to control each electrode 11 to 11c independently, all electrodes have the same polarity but the amount of the voltage may be different or at least different over time.

1. A nozzle (1) for generating an atmospheric pressure plasma having a monopolar electrode (11), wherein the nozzle (1) comprises a foil nozzle (10) with an upper and a lower foil (12, 13) between which a gas channel (16) is formed, a gas outlet (14) is formed in the upper foil (13) and the electrode (11) is exposed in the area of the outlet (14).

2. A nozzle (1) according to claim 1 wherein the nozzle (1) comprises a V-shaped recess (17) being formed on a tip (14) of the foil nozzle (10).

3. A nozzle (1) according to claim 1 wherein the foil nozzle (10) is flexible bendable in a direction orthogonally to the upper and lower surface of the foil (12, 13).

4. A nozzle (1) according to claim 1 wherein the foil nozzle (10) comprises multiple gas outlets (14-14c).

5. A nozzle (1) according to claim 3 wherein each of the outlets (14-14c) has a corresponding electrode tip (19-19c) and preferably a corresponding electrode (11-11c).

6. A nozzle (1) according to claim 1 wherein the upper and lower foil (12, 13) are connected to each other at their lateral end portions and at their tip portion.

7. A nozzle (1) according to claim 5 wherein the connection between the upper and lower foil (12, 13) is formed via a spacer forming a side wall (15) of the foil nozzle (10).

8. A nozzle (1) according to claim 6 wherein at least one gas outlet (14-14c) extends from the upper foil (13) into the side wall.

9. A nozzle (1) according to claim 7 wherein at least one gas outlet (14-14c) is located in the side wall (15).

10. A nozzle (1) according to claim 1 wherein the electrode (11) is formed of copper, preferably of copper with a gold plating.

11. A nozzle (1) according to claim 1 wherein at least one of the lower foil (12), the upper foil (13) and the side wall (15) is made of a flexible PCB material, preferably polyamide or FR4.

12. A nozzle (1) according to claim 1 wherein the electrode (11) is formed as a conductive track on the lower foil (12), particularly on the inner surface of the lower foil (12).

13. A nozzle (1) according to claim 1 wherein the electrode (11) is partially coated with a varnish (18) as an insulator.

14. A nozzle (1) according to one claim 1 wherein the nozzle (1) comprises a connector (20) at a rear section of the foil nozzle (10).

15. A nozzle (1) according to claim 14 wherein the connector (20) comprises a gas inlet (24) and an electrical connector (19′) and is preferably formed of plastic, more preferably of molded plastic.
